(19) United States
(12) Patent Application Publication
(10) Pub. No.: US 2007/0081326 A1
(43) Pub. Date: Apr. 12, 2007

(54) PORTABLE WORK LIGHT

(76) Inventors: Duane D. Robinson, Sterling Heights, MI (US); Jared G. Springer, Washington, MI (US)

Correspondence Address: ARTZ & ARTZ, P.C., 28333 TELEGRAPH RD., SUITE 250, SOUTHFIELD, MI, 48034, US

(21) Appl. No.: 11/161,471

(22) Filed: Aug. 4, 2005

(51) Int. Cl. F21L 4/00

(52) U.S. Cl. 362/157

(57) ABSTRACT

A portable light (10) includes a harness (12). Multiple illumination sources (14) are contained within the harness (12). A power source (16) is electrically coupled to the illumination sources (14). The portable light (10) also includes one or more of an alignment-maintaining mechanism (22), a separation-maintaining mechanism (24), and a position-maintaining mechanism (26). The alignment-maintaining mechanism (22) may be contained within the harness (12) and is coupled to and maintains the orientation of the illumination sources. The separation-maintaining mechanism (24) may be contained within the harness (12) and is coupled to and maintains the separation distances between the illumination sources (14). The position-maintaining mechanism (26) maintains the orientation of the harness (12).

### TECHNICAL FIELD

The present invention is related to flashlights, working lights, portable lights, and the like.

### BACKGROUND OF THE INVENTION

Portable lights, such as flashlights and working lights, currently exist and are used throughout industry for various tasks. The lights are used in commercial, residential, and various other environments. Portable lights are utilized to illuminate open areas and confined or normally unlit areas. In confined areas, the portable lights aid in illuminating difficult to reach areas where ceiling or wall mounted lights, such as those lights that receive power via wire from a wall mounted outlet, are unable to reach.

For example, portable lights are utilized within containers, such as in a handbag, a purse, a travel bag, or a trunk of a vehicle, to provide an improved view of the interior contents of the containers and to aid in locating an item contained therein. As another example, portable lights are utilized to work on vehicles, such as automotive vehicles or boats, and to perform maintenance tasks. Portable lights are also used for recreational purposes, such as when camping, walking, or jogging to illuminate the nearby environment. There are an endless number of applications for portable lights and all of which are clearly not presented herein.

Current portable lights, however, are limited in there functionality. Some portable lights provide only a single, directed, or focused illumination. Other lights lack flexibility and position or orientation maintaining characteristics. One portable light that currently exists includes a battery case, which is coupled to a transparent tube. The transparent tube contains a series of light bulbs or lamps that are connected in parallel and which receive power from batteries contained within the battery case. Although this portable light provides widespread illumination, is somewhat flexible, and allows for reorientation of the lamps, its flexibility is limited and it has other associated functional limitations, which are common among other portable lights.

One common limitation is the inability to maintain the orientation of the lamps or to direct the illumination from the lamps in a desired direction, thus preventing efficient use of the light source. Another common limitation is the inability to maintain separation distance between the lamps. When the separation distance is not maintained inconsistent or irregular illumination results. Another limitation is the inability to maintain a desired orientation while still providing flexibility. For example, transparent tubes, although flexible, tend to “spring” back or return to a minimally curved, minimally bent, or steady-state orientation over time. Also, transparent tubes when bent beyond a certain extent can become kinked, which can degrade the functionality thereof.

Thus, there exists a need for an improved portable light that overcomes the above-described limitations. It is desirable that the improved portable light also provides improved flexibility.

### SUMMARY OF THE INVENTION

Several embodiments of the present invention provide a portable light that includes a harness. Multiple illumination sources are contained within the harness. A power source is electrically coupled to the illumination sources. The portable light also includes one or more of an alignment-maintaining mechanism, a separation-maintaining mechanism, and a position-maintaining mechanism. The alignment-maintaining mechanism may be contained within the harness and is coupled to the illumination sources. The separation-maintaining mechanism may be contained within the harness and is coupled to the illumination sources. The position-maintaining mechanism maintains the orientation of the harness.

The embodiments of the present invention provide several advantages. One such advantage is the provision of a portable flexible light that has multiple illumination sources and an alignment-maintaining mechanism. The alignment mechanism maintains the orientation of the illumination sources. The alignment mechanism allows for efficient and directional use of the light generated by the illumination sources.

Another advantage provided by an embodiment of the present invention, is the provision of a portable flexible light that has multiple illumination sources and a separation-maintaining mechanism. The separation-maintaining mechanism maintains the separation distances between the light sources to provide uniform lighting.

Still another advantage provided by an embodiment of the present invention, is the provision of a portable flexible light that has multiple illumination sources and a position-maintaining mechanism. The position-maintaining mechanism maintains orientation of the harness of the portable light and thus aids in maintaining the orientation of the illumination sources.

Another advantage provided by an embodiment of the present invention, is the provision of a portable flexible light that has multiple illumination sources and a harness configured for improved flexibility.

Yet another advantage provided by an embodiment of the present invention, is the provision of a portable flexible light that is water resilient and buoyant.

The present invention itself, together with further objects and attendant advantages, will be best understood by reference to the following detailed description, taken in conjunction with the accompanying drawing.

Other features, benefits and advantages of the present invention will become apparent from the following description of the invention, when viewed in accordance with the attached drawings and appended claims.

### BRIEF DESCRIPTION OF THE DRAWINGS

For a more complete understanding of this invention reference should now be made to embodiments illustrated in greater detail in the accompanying figures and described below by way of examples of the invention wherein:

FIG. 1 is a side cross-sectional view of a portable working light in accordance with an embodiment of the present invention.

FIG. 2 is a side cross-sectional view of a portable working light in accordance with another embodiment of the present invention.

FIG. 3 is a schematic view of a separation-maintaining mechanism in accordance with an embodiment of the present invention.

FIG. 4 is a schematic view of a separation-maintaining mechanism in accordance with another embodiment of the present invention.

FIG. 5 is a schematic view of a portable working light circuit in accordance with an embodiment of the present invention.

FIG. 6 is a schematic and block diagrammatic view of a portable working light circuit in accordance with a couple embodiments of the present invention.

FIG. 7 is a cross-sectional view of a harness in accordance with another embodiment of the present invention.

FIG. 8 is a logic flow diagram illustrating a method of assembling a portable working light in accordance with an embodiment of the present invention.

### DETAILED DESCRIPTION

In the following Figures the same reference numerals will be used to refer to the same components. The present invention may be applied in aeronautical, automotive, nautical, and railway applications, as well as in commercial and residential applications. The present invention may be used as a maintenance tool to illuminate confined and difficult to reach areas. The present invention may also be utilized in recreational applications, such as camping, biking, walking, skiing, and other recreational activities. Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

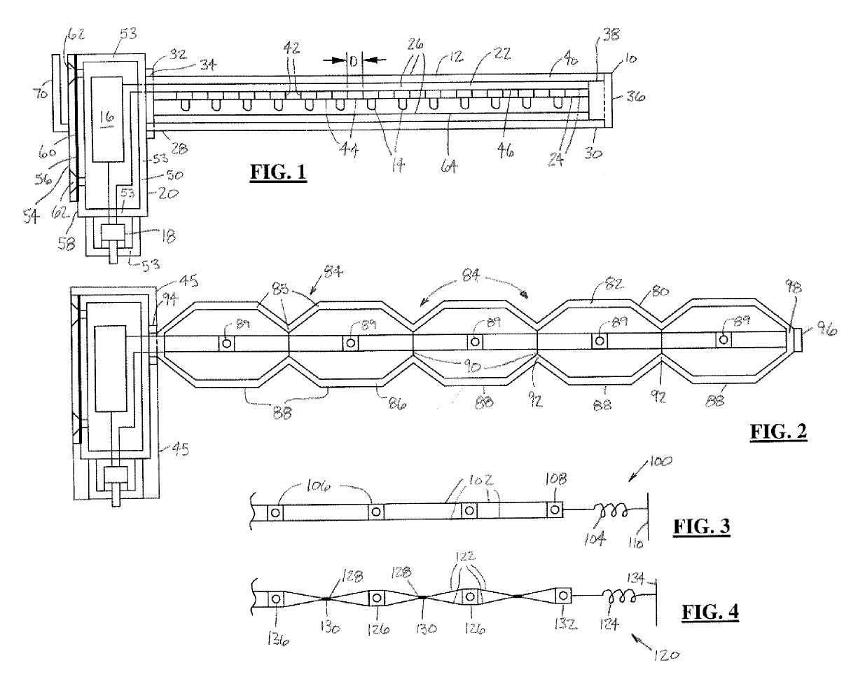

Referring now to FIG. 1, a side cross-sectional view of a portable working light 10 in accordance with an embodiment of the present invention is shown. The portable light 10 includes a flexible harness 12. One or more series of illumination devices 14 (only one series is shown) are deposed and positioned along and within the harness 12. The illumination devices 14 receive power from a power source 16 and are activated via one or more switches 18 (only one is shown). The power source 16 and the switches 18 reside within a housing 20. The portable light 10 may include one or more alignment-maintaining mechanisms 22, separation-maintaining mechanisms 24, and position-maintaining mechanisms 26, examples of which are shown.

The harness 12 includes a first end 28 and a second or opposing end 30. In the example embodiment shown, the harness 12 is tubular in design and is coupled and sealed to the housing 20 via a housing connector 32. The housing connector 32 may be secured to the housing 20 via fasteners (not shown) or may be threaded into the housing 20, clipped to the housing 20, or secured using some other attachment mechanism known in the art. The housing connector 32 provides a first watertight seal 34 between the housing 20 and the first end 28. The second end 30 is plugged via an end cap 36 or the like. A second watertight seal 38 exists between the harness 12 and the end cap 36. The housing 20, housing connector 32, and end cap 36 may be of various types and styles.

The harness 12 is at least partially transparent to allow for transmission of light through the wall 40 thereof. The harness 12 may be formed of rubber, plastic, polyurethane, or other transparent material or combination thereof. The material of the harness 12 is such that it is flexible, position retainable, durable, and resilient to kinking and cracking over time and due to exposure within environments that have a large range of temperatures or temperature variations.

The illumination devices 14 are uniformly and equidistantly separated at predetermined distances D. In one embodiment, the illumination devices 14 are placed on one-inch centers. The illumination devices 14 are shown as high output LEDs, which are directed in the same direction and along a single plane of illumination. Of course, other illumination devices known in the art may be utilized and the illumination devices 14 may be directed in different directions. The LEDs are unidirectional and provide illumination in a desired direction. The illumination output and angle of the LEDs may vary depending upon the application. As an example, the LEDs may have an illumination rating of approximately between 3,000-10,000 mcds (millicandles). The illumination devices 14 may have any illumination rating.

The illumination devices 14 are mounted or attached to illumination device holders or sockets 42, which may be electrically coupled in parallel or series. The sockets 42 may be electrically coupled via wires, a conductive film, or a flexible circuit; wires 44 are shown. In the embodiment shown, the sockets 42 are attached to a band or spine 46. The spine 46 may be attached to the housing connector 32 and the end cap 36. The sockets 42 are attached to the spine 46 and may be uniformly and equidistantly separated by approximately a predetermined distance D. The predetermined distance D is approximately maintained by the separation mechanisms 24. For example, the separation mechanisms 24 may include the spine 46, which may be attached and be retained in tension to prevent the sockets 42 from sliding or shifting within the harness 12. Maintenance of the separation distances between the illumination sources 14 provides uniform lighting.

The power source 16 may be of various types and styles. The power source 16 may be in the form of one or more batteries and may be rechargeable. The power source 16 may include solar cells or other power receiving, converting, or generating devices.

The switches 18 may also be of various types and styles. In one embodiment, a single water resistant switch is utilized. The switches 18 may be in the form of toggle switches, push-button switches, rotary switches or dials, or other switches known in the art. Rotary dials may be utilized to provide variable illumination through adjustment of the amount of current passing to the illumination devices 14. The switches 18 may be discontinuous after a predetermined length of time to prevent power source drain when the portable light 10 is not in use. The switches 18 may be activated or switched to an “ON” state by one or more sensors (not shown), such as motion sensors.

The housing 20 includes a first chamber 50 and a second chamber 52 that have walls 53. The power source 16 is disposed within the first chamber 50 and the switches 18 are disposed within the second chamber 52. The housing 20 may include any number of chambers.

The housing 20 includes an access door or panel 54, which allows for replacement of the power source 16. The housing 20 is sealed and water resistant. A third watertight seal 56 exists between the access panel 54 and the main body 58 of the housing 20. The third watertight seal 56 may be formed through the use of a gasket or o-ring 60 that resides between the access panel 54 and the main body 58. The o-ring 60 assists in preventing leaks. Fasteners 62 may be used to attach the access panel 54 to the main body 58. The fasteners 62 may be recessed into the access panel 54 such that they are flush therewith when secured. Although the fasteners 62 are shown as screws, the fasteners 62 may be of various types and styles.

In another embodiment of the present invention, the harness 12 and the housing 20 are configured to provide buoyancy or in other words to allow the portable light 10 to float when in a liquid, such as water. The harness 12 and the housing 20 are formed of materials and are sized to promote buoyancy of the portable light 10. The materials used are lightweight. The harness 14 and the housing 20 are sized such that the portable light 10 displaces an appropriate amount of liquid to provide adequate buoyant force F_{b} to overcome the weight of the portable light and thus assure buoyancy. Expression 1, which is based on Archimedes principle, is provided as an example that may be used to determine volume v_{d} of the immersed portion of the portable light 10 that is desired to provide buoyancy.
F_{b}=ρ_{w}gv_{d}>m_{light}g (1)

The weight of the portable light is represented by and is equal to the mass might of the light multiplied by gravity g. The density of water is represented by P_{w}.

To provide buoyancy, the housing may be wrapped or disposed within a wrap, such as a foam wrap 45, which is shown in FIG. 2. The wrap may be removable and may fully or partially cover the housing 20, as well as the harness 12. The wrap may be formed of various buoyant materials and may be transparent or non-transparent.

The harness 12, spine 46, and electrical connections between sockets 42, such as wires 44, are formed of materials and are configured to be resilient to continuous bending and various levels of tension depending upon the orientation of the harness 12. This prevents splitting, cracking, and breaking of the harness 12, spine 46, and the electrical connections. For example, the harness 12 may be formed of a urethane rubber, which provides such characteristics. As another example the electrical connections may be formed of a flexible and stranded wire.

The alignment mechanisms 22, the separation mechanisms 24, and the position mechanisms 26 may be separate and distinct mechanisms or may be one in the same. For example, the alignment mechanisms 22 and the position mechanisms 24 may include the spine 46. The spine 46 maintains orientation of the illumination devices 14 such that they direct illumination along a single plane. The spine 46 may be longitudinally flexible, but laterally stiff such that it resists twisting motion thereof. The spine 46 also may aid in maintaining the orientation of the harness 12, such that when the harness 12 is bent or moved into a desired position the spine 46 retains that position.

The alignment mechanisms 22, the separation mechanisms 24, and the position mechanisms 26 may include an illumination source holder, an adhesive material, an illumination source wire, a spine, a tension wire, an elastic cord, a band, a string, a crossing element, a strip, a spring, and other similar mechanisms known in the art, some of which are described herein and shown in FIGS. 1-7. For example, an adhesive material may be used to secure the band 46 to the harness 12.

In one embodiment, the position mechanisms 26 include a tension wire 64, as shown. The tension wire 64 extends between the housing connector 32 and the end cap 36 and may also be in tension and relatively stiff as to maintain its position. The tension wire 64 may be stiff, such that a minimum predetermined level of force must be applied to the wire to change its orientation. This minimum level of force allows the portable light 10 to maintain its orientation even when under its own weight or portions thereof. For example, the portable light 10 may be bent or curved so that it can hang from or be hooked on an object. The tension wire 64 prevents the portable light 10 from changing orientation and becoming unhooked.

The harness 12, the spine 46, the tension wire 64, and the electrical connections between the sockets 14, have poor memory behavior characteristics or low levels of spring back. The material properties of the stated devices are such that the devices remain in their latest position or orientation unless acted upon. Also, the spine 46, the tension wire 64, and other similar devices aid in preventing kinking of the harness 12.

The separation mechanisms 24 may also include the spine 46 and/or the electrical connections. The spine 46 and/or electrical connections may be in tension and coupled to the first end 28 and the second end 30, such as to the housing connector 32 and the end cap 36, as shown. This coupling maintains the spine 46 and/or electrical connections in a taught state and thus maintains separation distances between the illumination devices 14 and the sockets 42. In another embodiment, the harness 12 is filled with a transparent/adhesive material or formed around the illumination devices 14 and the sockets 42 such that the sockets 42 and the illumination devices 14 are held in place. Note that when the harness 12 is filled with a transparent material or is formed around the illumination devices 14 and the sockets 42 that the housing connector 32 and the end cap 36 may not be utilized. Furthermore, when the transparent material is one that solidifies, this solidification may provide a watertight seal. The material of the harness 12 when molded around the illumination devices 14 and the sockets 42 may also provide a watertight seal.

The portable light 10 may also include an attachment mechanism or mounting element 70. The mounting element 70 may be in the form of a clip, as shown, a hook, a clasp, a hook and loop strap, or may be in some other form known in the art. For example, the mounting element 70 may be in the form of a magnet. The mounting element 70 may be a separate component that is attached to the housing 20 or may be integrally formed as part of the housing 20. The mounting element 70 may be of various types, styles, sizes, and may be located anywhere on the portable light 10 including anywhere on the housing 20, the harness 12, or the end cap 36.

Referring now to FIG. 2, a side cross-sectional view of a portable working light 80 in accordance with another embodiment of the present invention is shown. The portable light 80 is similar to the portable light 10, however it includes a 3-point flexible harness 82 for increased flexibility. Although the harness 82 is shown as a 3-point harness, the harness 82 may be in various other configurations and have any number of points. The 3-point configuration provides increased bending capability in joint areas 84. Each joint area 84 has three associated points 85. The outer wall 86 of the harness 82 includes hexagonally-shaped portions 88. Each portion 88 has one or more associated illumination devices 89. The harness 82 may include joint members 90 that extend laterally across the joint areas 84 and maintain the relationship between centrically recessed points 92.

The portable light 80 also includes a housing connector 94 and an end cap 96, which are configured for the harness 82. Like the harness 12, the harness 82 extends within the housing connector 94 and creates a watertight seal therein. The end cap 96 is coupled to the end 98 of the harness 82 and allows for attachment of the electrical connections, as shown, or other alignment, separation, or position-maintaining mechanisms.

Referring now to FIG. 3, a schematic view of a separation-maintaining mechanism 100 in accordance with an embodiment of the present invention is shown. The separation mechanism 100 includes electrical connections 102 and a tension-maintaining element 104. The electrical connections 102 extend in a parallel format between the sockets 106. The tension element 104 is coupled between the last or end socket 108 and an end cap 110, such as one of the end caps 36 or 96. Although the tension element 104 is shown as being in the form of a spring, which is in tension, the tension element 104 may be in some other form known in the art. Non-conductive members (not shown) may be used in replacement of or in combination with the electrical connections 102 to maintain separation between the sockets 106. The non-conductive members may be adhered to the sockets 106. The non-conductive members may be in the form of string, elastic cords, or other flexible and elastic members known in the art.

Referring now to FIG. 4, a schematic view of a separation-maintaining mechanism 120 in accordance with another embodiment of the present invention is shown. The separation mechanism 120 includes cross-members 122 and a tension-maintaining element 124. The cross-members 122 extend between the sockets 126. Cross-coupling members 128 may be used to couple the cross-members 122 at the points 130 where the cross-members 122 cross each other. The tension member 124 is coupled between the end socket 132 and the end cap 134. The cross-members 122 and sockets 126 extend and contract in an accordion like fashion. The use of the cross-members 122 further aids in maintaining position of the illumination devices 136 and the separation therebetween. The cross-members 122 may be in the form of electrical connections or may be non-conductive and may be adhered to the sockets 126. The cross-members 122 may be in the form of string, elastic cords, or in some other form known in the art.

Referring now to FIG. 5, a schematic view of a portable working light circuit 140 in accordance with an embodiment of the present invention is shown. The circuit 140 is provided as one possible example circuit that may be used in and applied to the above-described embodiments of FIGS. 1-4. The circuit 140 includes a power source 142, a switch 144, a resistive element 146, and multiple illumination devices 148. The power source 142, the switch 144, and the resistive element 146 are coupled in series with each other and in parallel with the illumination devices 148. In one embodiment of the present invention, the resistive element 146 is a resistor that has a resistance of approximately between 10-50 Ohms.

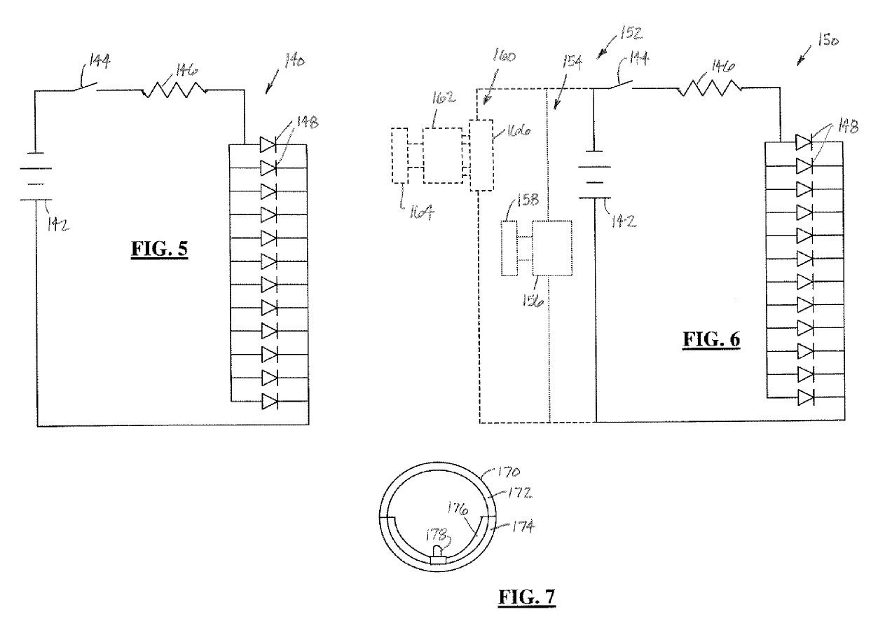

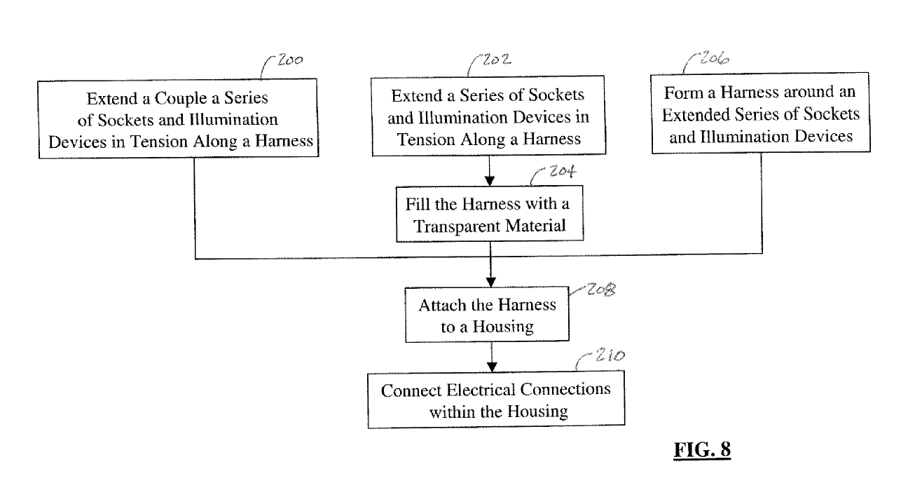

Referring again to FIG. 1 and also to FIG. 6, wherein a schematic and block diagrammatic view of a portable working light circuit 150 in accordance with a couple other embodiments of the present invention is shown. The working light circuit 150 may include an external power circuit 152, of which two examples are shown in hidden lines. The external power circuit 152 allows for the reception of power from an external power source in a residential or commercial setting, such as from a 110V AC outlet. The first example or external power circuit 154 includes a transformer circuit 156 and an adaptor 158 for receiving externally supplied power. The transformer circuit 156 may be contained within a housing, such as the housing 20, and coupled in parallel to the power source 142. The transformer circuit 156 may be, for example, a 110 VAC-to-12 VDC transformer. The transformer circuit 156 may include rectifiers, capacitors, and regulators, for providing AC-to-DC conversion. The adaptor 158 may be coupled to a wall of a housing or to an access panel, such as one of the walls 53 or the panel 54.

A second example or external power circuit 160 includes an externally connected transformer 162 and adaptor 164 that are coupled to the work light circuit 150 via an external power source connector 166. The power source connector 166 may also be coupled to a wall of a housing or to an access panel, such as one of the walls 53 or the panel 54. The connector 166 is coupled in parallel to the power source 142. The external power circuit 152 may include additional switches or isolation circuits as desired for separation from the power source 142.

Referring now to FIG. 7, a cross-sectional view of a harness 170 in accordance with another embodiment of the present invention is shown. The harness 170 includes an upper half 172 and a lower half 174. The harness 170 may be completely transparent or partially transparent, as shown. The upper half 172 is transparent and the lower half 174 is not transparent. The lower half 174 may be reflective or have a reflective film or layer 176 applied thereon. The reflectiveness of the lower half 174 and/or of the reflective layer 176 aids in further directing illumination from the illumination sources, such as the illumination source 178, in a desired direction. This directional illumination also provides efficient use of emitted light.

Referring now to FIG. 8, a logic flow diagram illustrating a method of assembling a portable working light in accordance with an embodiment of the present invention is shown.

In step 200, a series of illumination device sockets and corresponding illumination devices are extended and coupled in tension along a harness. The electrical connections or the alignment, separation, or position-maintaining mechanisms between the sockets may be coupled in tension. FIGS. 1-4 provide example configurations. The following steps 202-206 may be performed in alternative to step 200.

In step 202, a series of illumination device sockets and corresponding illumination sources are extended within and along a harness.

In step 204, the harness is filled with a transparent material. The electrical connections between the sockets may be held taught or in tension to prevent movement thereof while filling the harness.

In step 206, a harness is formed around a series of illumination device sockets and illumination devices. Again the electrical connections between the sockets may be held taught or in tension to prevent movement thereof during harness formation. Step 206 may be performed in replacement of steps 202 and 204.

In step 208, the harness is coupled to a housing, such as the housing 20. The harness may be partially extended within the housing and the attached to the housing via a housing connector, such as the housing connector 32.

In step 210, electrical connections extending from the harness are coupled to a power source and to one or more switches within the housing.

The above-described steps are meant to be illustrative examples; the steps may be performed sequentially, synchronously, simultaneously, or in a different order depending upon the application.

The present invention provides a portable working light that may be utilized in various applications. The portable light provides uniform directed lighting and increased flexibility and position maintaining characteristics. The present invention provides design versatility in providing multiple configurations and various alignment, separation, and position-maintaining mechanisms.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A portable light comprising:
a harness;
a plurality of illumination sources contained within said harness;
a power source electrically coupled to said illumination sources; and
an alignment-maintaining mechanism contained within said harness and coupled to and maintaining orientation of said plurality of illumination sources.

2. A light as in claim 1 wherein said harness is divided into light portions.

3. A light as in claim 1 wherein said harness comprises a plurality of hexagonally-shaped light portions.

4. A light as in claim 1 wherein said harness is a three-point grooved harness.

5. A light as in claim 1 further comprising an end cap coupled to an opposite end of said harness as said power source.

6. A light as in claim 1 wherein harness and said power source are water resilient.

7. A light as in claim 1 wherein said harness and said power source are buoyant.

8. A light as in claim 1 wherein said plurality of illumination sources are unidirectional.

9. A light as in claim 1 wherein said plurality of illumination sources are shock resilient.

10. A light as in claim 1 further comprising semi-flexible wire supplying power to said plurality of illumination sources, said wire bendable and position maintaining.

11. A portable light as in claim 1 wherein said alignment-maintaining mechanism comprises at least one of an illumination source holder, an illumination source wire, a spine, a strip, an adhesive material, a tension wire, an elastic cord, a band, string, a plurality of crossing members, and a spring.

12. A light as in claim 1 wherein said alignment-maintaining mechanism comprises a spring coupling at least one of said plurality of illumination sources to an end of said harness.

13. A light as in claim 1 wherein said alignment-maintaining mechanism maintains illumination from said plurality of illumination sources within a single plane.

14. A portable light comprising:
a harness;
a plurality of illumination sources contained within said harness;
a power source electrically coupled to said illumination sources; and
a separation-maintaining mechanism contained within said harness and coupled to and maintaining separation distances between said plurality of illumination sources.

15. A portable light as in claim 14 wherein said separation-maintaining mechanism comprises at least one of an illumination source holder, an illumination source wire, a spine, an elastic cord, an adhesive material, a tension wire, a strip, a band, a plurality of crossing members, a spring, and string.

16. A portable light as in claim 14 wherein said harness and said power source are water resilient and buoyant.

17. A portable light comprising:
a harness;
a plurality of illumination sources contained within said harness;
a power source electrically coupled to said illumination sources; and
a position-maintaining mechanism maintaining orientation of said harness.

18. A portable light as in claim 17 wherein said position-maintaining mechanism comprises at least one of an illumination source holder, an elastic cord, illumination source wire, a strip, an adhesive material, a spine, a tension wire, and a plurality of crossing members.

19. A light as in claim 17 wherein said harness is divided into light portions.

20. A light as in claim 17 wherein said harness and said power source are water resilient and buoyant.
